(19) United States
(12) Patent Application Publication
(10) Pub. No.: US 2016/0267884 A1
(43) Pub. Date: Sep. 15, 2016

(54) NON-UNIFORM RESCALING OF INPUT DATA FOR DISPLAYING ON DISPLAY DEVICE

(71) Applicant: Oculus VR, LLC, Menlo Park, CA (US)

(72) Inventors: Atman Jacob Binstock, Seattle, WA (US); Ryan Hamilton Brown, Palo Alto, CA (US); John Enders Robertson, Palo Alto, CA (US)

(21) Appl. No.: 15/067,387

(22) Filed: Mar. 11, 2016

Related U.S. Application Data
(60) Provisional application No. 62/132,360, filed on Mar. 12, 2015.

(51) Int. Cl. G09G 5/373; G06T 3/40; G06T 5/00; G06F 3/01

(52) U.S. Cl. CPC G09G 5/373; G06F 3/013; G06T 3/4007; G06T 5/002; G09G 2340/02; G09G 2340/0407

(57) ABSTRACT

A method for rescaling data to be displayed on a display device (e.g., an organic light emitting diode display device) is disclosed. The method includes receiving a frame of data for displaying on the display device, where the received data includes a first portion of the data corresponding to a first pixel region at a first pixel resolution and a second portion of the data corresponding to a second pixel region at a second pixel resolution lower than the first pixel resolution. The method also includes rescaling the received data for displaying the received data at a native pixel resolution of the display device, where the rescaling of the received data includes scaling the first portion of the data using a first scaling factor and the second portion of the data using a second scaling factor. The method further includes providing the rescaled data for displaying on the display device.

### CROSS REFERENCE TO RELATED APPLICATION

This application claims the benefit of U.S. Provisional Patent Application No. 62/132,360, filed Mar. 12, 2015, which is incorporated by reference in its entirety.

### BACKGROUND

This invention relates generally to displaying data on display devices, and more particularly to non-uniform rescaling of input data for displaying on display devices such as organic light emitting diode display devices.

Electronic displays such as liquid crystal displays (LCD) and organic light emitting diode (OLED) displays can display images with high resolution. For example, televisions can display in high-definition television (HDTV at 1080 p) or ultra-high-definition television (UHDTV at 2160 p or “4K UHD”). As the native display resolution capability of the displays increases, the bandwidth required to drive the display at its native resolution also increases and can exceed the link limitations, consume excessive power, or cause unwanted latency.

### SUMMARY

A method for rescaling data to be displayed on a display device (e.g., an organic light emitting diode display device) of a head-mounted display (HMD) is disclosed. The HMD receives the data from a host system without exceeding the limits of the link between the host system and the HMD. One way of avoiding exceeding the link limitation is to scale down the resolution of a portion of the data that corresponds to the user's peripheral vision in the HMD, as opposed to a portion of data corresponding to the user's central vision of the display device. The received data is then rescaled at the HMD such that data corresponding to the whole display device is at full resolution as described below.

The method includes receiving a frame of data for displaying on the display device, where the received data includes a first portion of the data corresponding to a first pixel region at a first pixel resolution (e.g., native resolution of the OLED display deice) and a second portion of the data corresponding to a second pixel region, wherein the second portion of the data is at a second pixel resolution lower than the first pixel resolution. The method also includes rescaling the received data for displaying the received data at a native resolution of the display device, where the rescaling of the received data includes scaling the first portion of the data using a first scaling factor (e.g., 1.0) and the second portion of the data using a second scaling factor (e.g., 0.5). The method further includes providing the rescaled data for displaying on the display device.

In one embodiment, the received frame of data includes a mapping between the first pixel region and the first scaling factor, and the second pixel region and the second scaling factor. The scaling factors and their mapping to various pixel regions of the display device may be either fixed or may vary over time. Their variation over time may be based on where the user is looking at on the display device (e.g., using eye tracking) or based on the characteristics of content being displayed on the display device.

In one embodiment, the received frame of data may be compressed to reduce the size of the data, and the first scaling factor and the second scaling factor may be determined based on the properties of compression used for compressing the data.

### BRIEF DESCRIPTION OF THE DRAWINGS

FIG. 1 is a block diagram of a system environment including a virtual reality system, in accordance with an embodiment.

FIG. 2A is a diagram of a virtual reality headset, in accordance with an embodiment.

FIG. 2B is a cross section of a front rigid body of the VR headset in FIG. 2A, in accordance with an embodiment.

FIG. 3 is a block diagram of system architecture for non-uniform rescaling of input data for displaying on an organic light emitting diode (OLED) display device, in accordance with an embodiment.

FIG. 4A is a diagram depicting a mapping of a region-based non-uniform rescaled data to be displayed on an OLED display device, in accordance with an embodiment.

FIG. 4B is a diagram depicting a mapping of a radial uniform rescaled data to be displayed on an OLED display device, in accordance with an embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### System Overview

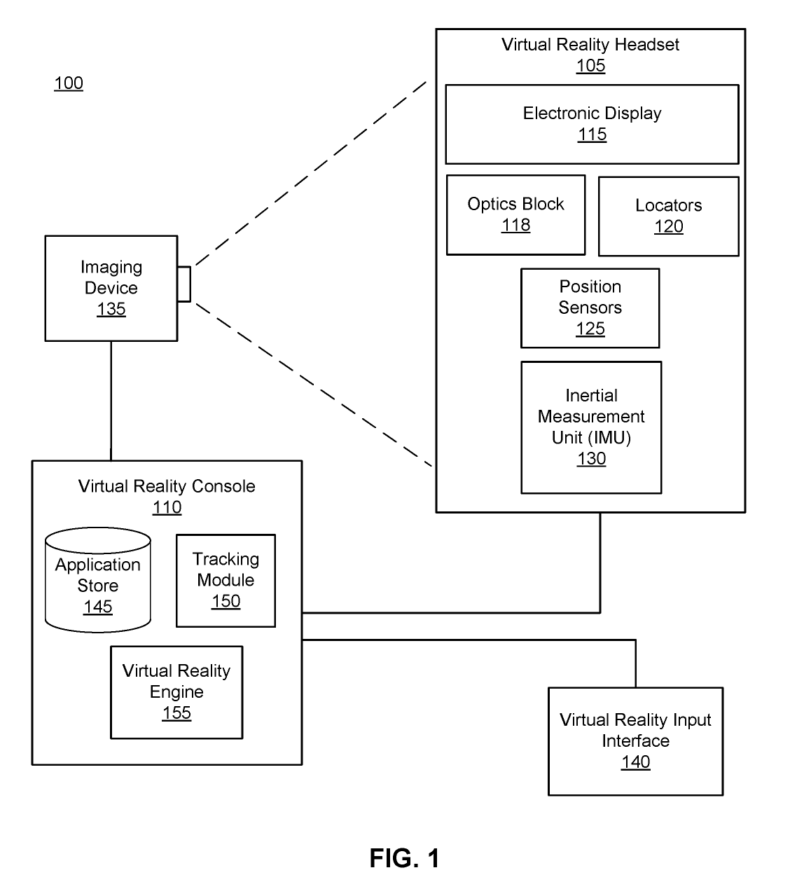

FIG. 1 is a block diagram of a virtual reality (VR) system environment 100 in which a VR console 110 operates. The system environment 100 shown by FIG. 1 comprises a VR headset 105, an imaging device 135, and a VR input interface 140 that are each coupled to the VR console 110. While FIG. 1 shows an example system 100 including one VR headset 105, one imaging device 135, and one VR input interface 140, in other embodiments any number of these components may be included in the system 100. For example, there may be multiple VR headsets 105 each having an associated VR input interface 140 and being monitored by one or more imaging devices 135, with each VR headset 105, VR input interface 140, and imaging devices 135 communicating with the VR console 110. In alternative configurations, different and/or additional components may be included in the system environment 100.

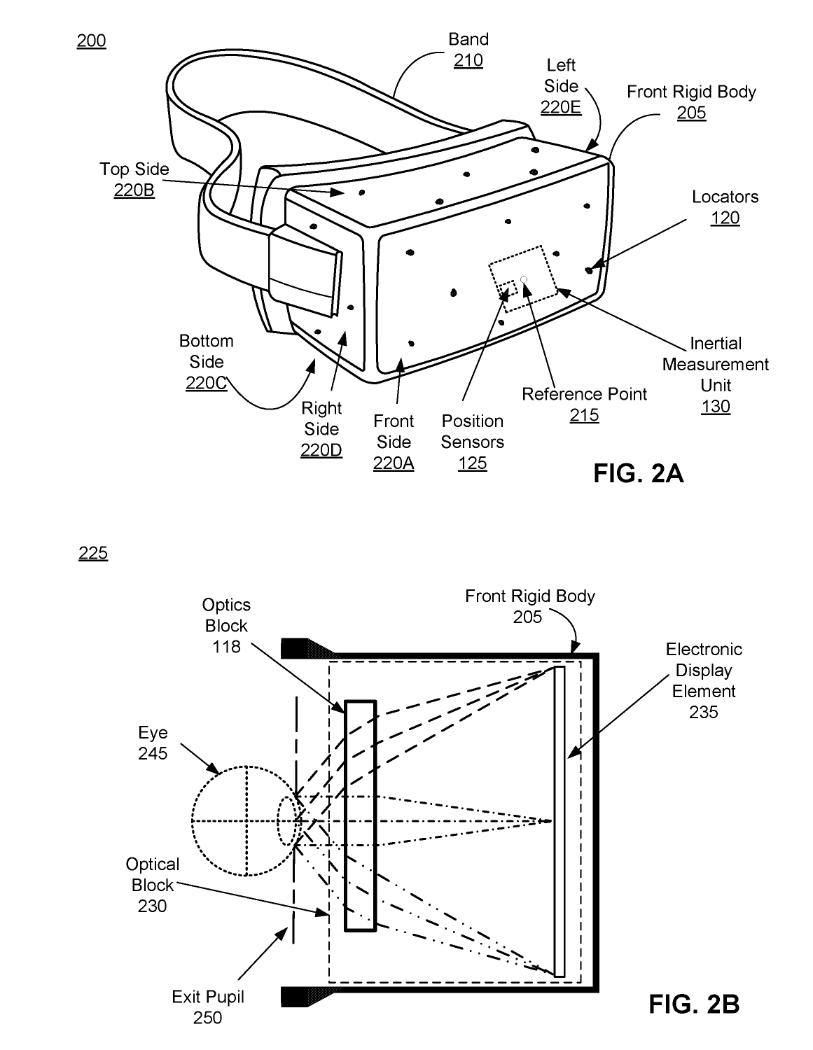

The VR headset 105 is a head-mounted display that presents media to a user. Examples of media presented by the VR head set include one or more images, video, audio, or some combination thereof. In some embodiments, audio is presented via an external device (e.g., speakers and/or headphones) that receives audio information from the VR headset 105, the VR console 110, or both, and presents audio data based on the audio information. An embodiment of the VR headset 105 is further described below in conjunction with FIGS. 2A and 2B. The VR headset 105 may comprise one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The VR headset 105 includes an electronic display 115, an optics block 118, one or more locators 120, one or more position sensors 125, and an inertial measurement unit (IMU) 130. The electronic display 115 displays images to the user in accordance with data received from the VR console 110. In various embodiments, the electronic display 115 may comprise a single electronic display or multiple electronic displays (e.g., a display for each eye of a user). Examples of the electronic display 115 include: a liquid crystal display (LCD), an organic light emitting diode (OLED) display, an active-matrix organic light-emitting diode display (AMOLED), a passive-matrix organic light-emitting diode display (PMOLED), some other display, or some combination thereof.

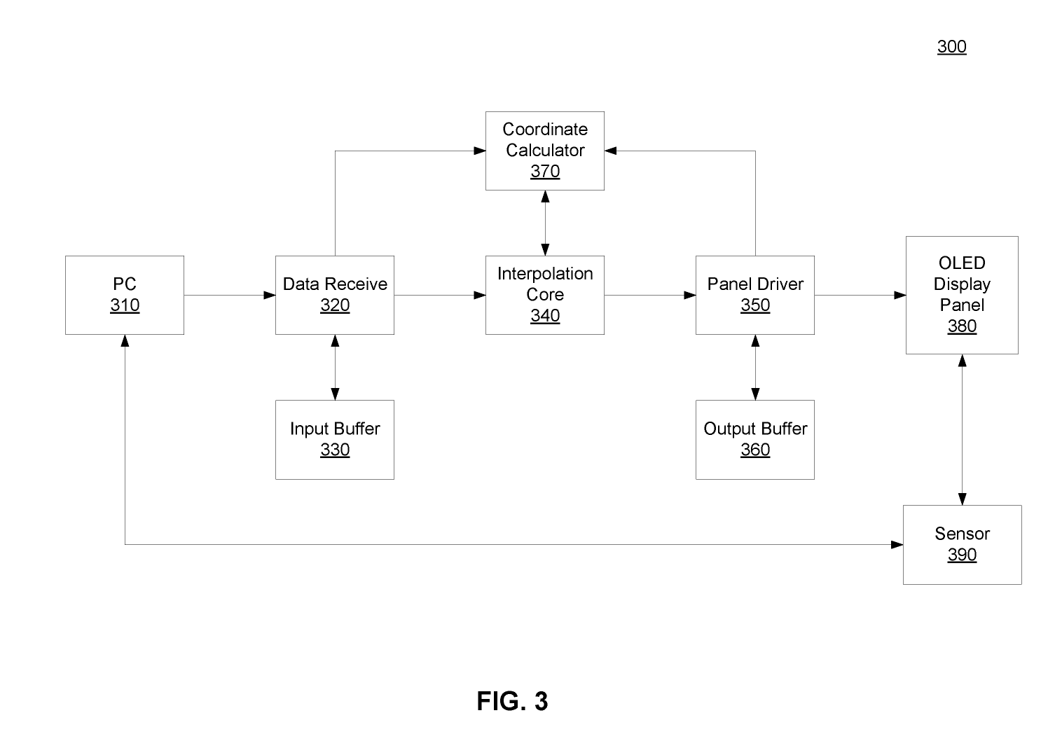

The electronic display 115 includes a display area comprising a plurality of pixels, where each pixel is a discrete light emitting component. An example embodiment of the pixel structure of electronic display 115 is described below with reference to FIG. 3. In some embodiments, each pixel comprises a plurality of sub-pixels, where a sub-pixel is a discrete light emitting component. Different sub-pixels are separated from each other by dark space. For example, a sub-pixel emits red light, yellow light, blue light, green light, white light, or any other suitable color of light. In some embodiments, images projected by the electronic display 115 are rendered on the sub-pixel level. This is distinct from, say an RGB (red-green-blue) layout, which has discrete red, green, and blue pixels (red, green, and blue) and each pixel in the RGB layout includes a red sub-pixel, which is adjacent to a green sub-pixel that is adjacent to a blue sub-pixel; the red, green, and blue sub-pixels operate together to form different colors. In an RGB layout a sub-pixel in a pixel is restricted to working within that pixel. However, in some embodiments, sub-pixels in the electronic display operate within multiple “logical” pixels in their surrounding vicinity to form different colors. The sub-pixels are arranged on the display area of the electronic display 115 in a sub-pixel array. Examples of a sub-pixel array include PENTILE® RGBG, PENTILE® RGBW, some another suitable arrangement of sub-pixels that renders images at the sub-pixel level. In some embodiments, one or more adjacent sub-pixels are of the same color.

In various embodiments, the display area of the electronic display 115 arranges sub-pixels in a hexagonal layout, in contrast to a rectangular layout used by conventional RGB type systems. Moreover, some users are more comfortable viewing images which appear to have been generated via a rectangular layout of sub-pixels.

The optics block 118 magnifies received light, corrects optical errors associated with the image light, and presents the corrected image light to a user of the VR headset 105. An optical element may be an aperture, a Fresnel lens, a convex lens, a concave lens, a filter, or any other suitable optical element that affects the blurred image light. Moreover, the optics block 118 may include combinations of different optical elements. In some embodiments, one or more of the optical elements in the optics block 118 may have one or more coatings, such as anti-reflective coatings.

Magnification of the image light by the optics block 118 allows the electronic display 115 to be physically smaller, weigh less, and consume less power than larger displays. Additionally, magnification may increase a field of view of the displayed media. For example, the field of view of the displayed media is such that the displayed media is presented using almost all (e.g., 110 degrees diagonal), and in some cases all of the user's field of view.

The locators 120 are objects located in specific positions on the VR headset 105 relative to one another and relative to a specific reference point on the VR headset 105. A locator 120 may be a light emitting diode (LED), a corner cube reflector, a reflective marker, a type of light source that contrasts with an environment in which the VR headset 105 operates, or some combination thereof. In embodiments where the locators 120 are active (i.e., an LED or other type of light emitting device), the locators 120 may emit light in the visible band (˜380 nm to 750 nm), in the infrared (IR) band (˜750 nm to 1 mm), in the ultraviolet band (10 nm to 380 nm), some other portion of the electromagnetic spectrum, or some combination thereof

In some embodiments, the locators 120 are located beneath an outer surface of the VR headset 105, which is transparent to the wavelengths of light emitted or reflected by the locators 120 or is thin enough to not substantially attenuate the wavelengths of light emitted or reflected by the locators 120. Additionally, in some embodiments, the outer surface or other portions of the VR headset 105 are opaque in the visible band of wavelengths of light. Thus, the locators 120 may emit light in the IR band under an outer surface that is transparent in the IR band but opaque in the visible band.

The IMU 130 is an electronic device that generates fast calibration data based on measurement signals received from one or more of the position sensors 125. A position sensor 125 generates one or more measurement signals in response to motion of the VR headset 105. Examples of position sensors 125 include: one or more accelerometers, one or more gyroscopes, one or more magnetometers, another suitable type of sensor that detects motion, a type of sensor used for error correction of the IMU 130, or some combination thereof. The position sensors 125 may be located external to the IMU 130, internal to the IMU 130, or some combination thereof.

Based on the one or more measurement signals from one or more position sensors 125, the IMU 130 generates fast calibration data indicating an estimated position of the VR headset 105 relative to an initial position of the VR headset 105. For example, the position sensors 125 include multiple accelerometers to measure translational motion (forward/back, up/down, left/right) and multiple gyroscopes to measure rotational motion (e.g., pitch, yaw, roll). In some embodiments, the IMU 130 rapidly samples the measurement signals and calculates the estimated position of the VR headset 105 from the sampled data. For example, the IMU 130 integrates the measurement signals received from the accelerometers over time to estimate a velocity vector and integrates the velocity vector over time to determine an estimated position of a reference point on the VR headset 105. Alternatively, the IMU 130 provides the sampled measurement signals to the VR console 110, which determines the fast calibration data. The reference point is a point that may be used to describe the position of the VR headset 105. While the reference point may generally be defined as a point in space; however, in practice the reference point is defined as a point within the VR headset 105 (e.g., a center of the IMU 130).

The IMU 130 receives one or more calibration parameters from the VR console 110. As further discussed below, the one or more calibration parameters are used to maintain tracking of the VR headset 105. Based on a received calibration parameter, the IMU 130 may adjust one or more IMU parameters (e.g., sample rate). In some embodiments, certain calibration parameters cause the IMU 130 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

The imaging device 135 generates slow calibration data in accordance with calibration parameters received from the VR console 110. Slow calibration data includes one or more images showing observed positions of the locators 120 that are detectable by the imaging device 135. The imaging device 135 may include one or more cameras, one or more video cameras, any other device capable of capturing images including one or more of the locators 120, or some combination thereof. Additionally, the imaging device 135 may include one or more filters (e.g., used to increase signal to noise ratio). The imaging device 135 is configured to detect light emitted or reflected from locators 120 in a field of view of the imaging device 135. In embodiments where the locators 120 include passive elements (e.g., a retroreflector), the imaging device 135 may include a light source that illuminates some or all of the locators 120, which retro-reflect the light towards the light source in the imaging device 135. Slow calibration data is communicated from the imaging device 135 to the VR console 110, and the imaging device 135 receives one or more calibration parameters from the VR console 110 to adjust one or more imaging parameters (e.g., focal length, focus, frame rate, ISO, sensor temperature, shutter speed, aperture, etc.).

In some embodiments, the imaging device 135 and the locators 120 may function as a positional tracking system that may track the position of the one or more locators 120 and reports to the VR console 110. The imaging device 135 may include one or more sensors (e.g., focal plane array including an array of light sensing pixels) that track the position of the locators 120 and report their positional information to the VR console 110, and the imaging device 135 receives one or more calibration parameters from the VR console 110 to adjust one or more imaging and/or sensing parameters.

The VR input interface 140 is a device that allows a user to send action requests to the VR console 110. An action request is a request to perform a particular action. For example, an action request may be to start or end an application or to perform a particular action within the application. The VR input interface 140 may include one or more input devices. Example input devices include: a keyboard, a mouse, a game controller, or any other suitable device for receiving action requests and communicating the received action requests to the VR console 110. An action request received by the VR input interface 140 is communicated to the VR console 110, which performs an action corresponding to the action request. In some embodiments, the VR input interface 140 may provide haptic feedback to the user in accordance with instructions received from the VR console 110. For example, haptic feedback is provided when an action request is received, or the VR console 110 communicates instructions to the VR input interface 140 causing the VR input interface 140 to generate haptic feedback when the VR console 110 performs an action.

The VR console 110 provides media to the VR headset 105 for presentation to the user in accordance with information received from one or more of: the imaging device 135, the VR headset 105, and the VR input interface 140. In the example shown in FIG. 1, the VR console 110 includes an application store 145, a tracking module 150, and a virtual reality (VR) engine 155. Some embodiments of the VR console 110 have different modules than those described in conjunction with FIG. 1. Similarly, the functions further described below may be distributed among components of the VR console 110 in a different manner than is described here.

The application store 145 stores one or more applications for execution by the VR console 110. An application is a group of instructions, that when executed by a processor, generates content for presentation to the user. Content generated by an application may be in response to inputs received from the user via movement of the HR headset 105 or the VR interface device 140. Examples of applications include: gaming applications, conferencing applications, video playback application, or other suitable applications.

The tracking module 150 calibrates the VR system 100 using one or more calibration parameters and may adjust one or more calibration parameters to reduce error in determination of the position of the VR headset 105. For example, the tracking module 150 adjusts the focus of the imaging device 135 to obtain a more accurate position for observed locators on the VR headset 105. Moreover, calibration performed by the tracking module 150 also accounts for information received from the IMU 130. Additionally, if tracking of the VR headset 105 is lost (e.g., the imaging device 135 loses line of sight of at least a threshold number of the locators 120), the tracking module 140 re-calibrates some or all of the system environment 100.

The tracking module 150 tracks movements of the VR headset 105 using slow calibration information from the imaging device 135. The tracking module 150 determines positions of a reference point of the VR headset 105 using observed locators from the slow calibration information and a model of the VR headset 105. The tracking module 150 also determines positions of a reference point of the VR headset 105 using position information from the fast calibration information. Additionally, in some embodiments, the tracking module 150 may use portions of the fast calibration information, the slow calibration information, or some combination thereof, to predict a future location of the headset 105. The tracking module 150 provides the estimated or predicted future position of the VR headset 105 to the VR engine 155.

The VR engine 155 executes applications within the system environment 100 and receives position information, acceleration information, velocity information, predicted future positions, or some combination thereof of the VR headset 105 from the tracking module 150. Based on the received information, the VR engine 155 determines content to provide to the VR headset 105 for presentation to the user. For example, if the received information indicates that the user has looked to the left, the VR engine 155 generates content for the VR headset 105 that mirrors the user's movement in a virtual environment. Additionally, the VR engine 155 performs an action within an application executing on the VR console 110 in response to an action request received from the VR input interface 140 and provides feedback to the user that the action was performed. The provided feedback may be visual or audible feedback via the VR headset 105 or haptic feedback via the VR input interface 140.

FIG. 2A is a diagram of a virtual reality (VR) headset, in accordance with an embodiment. The VR headset 200 is an embodiment of the VR headset 105, and includes a front rigid body 205 and a band 210. The front rigid body 205 includes one or more electronic display elements of the electronic display 115 (not shown), the IMU 130, the one or more position sensors 125, and the locators 120. In the embodiment shown by FIG. 2A, the position sensors 125 are located within the IMU 130, and neither the IMU 130 nor the position sensors 125 are visible to the user. In some embodiments, the VR headset 200 may include two or more rigid bodies.

The locators 120 are located in fixed positions on the front rigid body 205 relative to one another and relative to a reference point 215. In the example of FIG. 2A, the reference point 215 is located at the center of the IMU 130. Each of the locators 120 emit light that is detectable by the imaging device 135. Locators 120, or portions of locators 120, are located on a front side 220A, a top side 220B, a bottom side 220C, a right side 220D, and a left side 220E of the front rigid body 205 in the example of FIG. 2A. In embodiments where the VR headset 200 includes two or more rigid bodies, locators 120 may be located each of the two or more rigid bodies.

FIG. 2B is a cross section 225 of the front rigid body 205 of the embodiment of a VR headset 200 shown in FIG. 2A. As shown in FIG. 2B, the front rigid body 205 includes an optical block 230 that provides altered image light to an exit pupil 250. The exit pupil 250 is the location of the front rigid body 205 where a user's eye 245 is positioned. For purposes of illustration, FIG. 2B shows a cross section 225 associated with a single eye 245, but another optical block, separate from the optical block 230, provides altered image light to another eye of the user. The optical block 230 includes an electronic display element 235 of the electronic display 115, and the optics block 118. An image that may be corrected for any errors is then generated by the optics block 118 magnifying the blurred image light. The optics block 118 directs the corrected image light to the exit pupil 250 for presentation to the user.

FIG. 3 is a block diagram of system architecture for non-uniform rescaling of input data for displaying on an OLED display device, in accordance with an embodiment. The system architecture includes a personal computer (PC) 310 (or a host system), data receive module 320, interpolation core module 340, panel driver 350, coordinate calculator module 370, input buffer 330, output buffer 360, OLED display panel 380, and optionally sensor 390. In one embodiment, the OLED display panel 380 can be incorporated as the electronic display 115 of the virtual reality (VR) headset 105 of VR system 100. In other embodiments, the OLED display panel 380 may be used as some other electronic display, e.g., a computer monitor, a television set, etc. In one embodiment where the PC 310 and the OLED display panel 380 support an embedded display port video link, the data receive module 320, interpolation core module 340, panel driver 350, coordinate calculator module 370, input buffer 330, and output buffer 360 may be located within the OLED display panel 380.

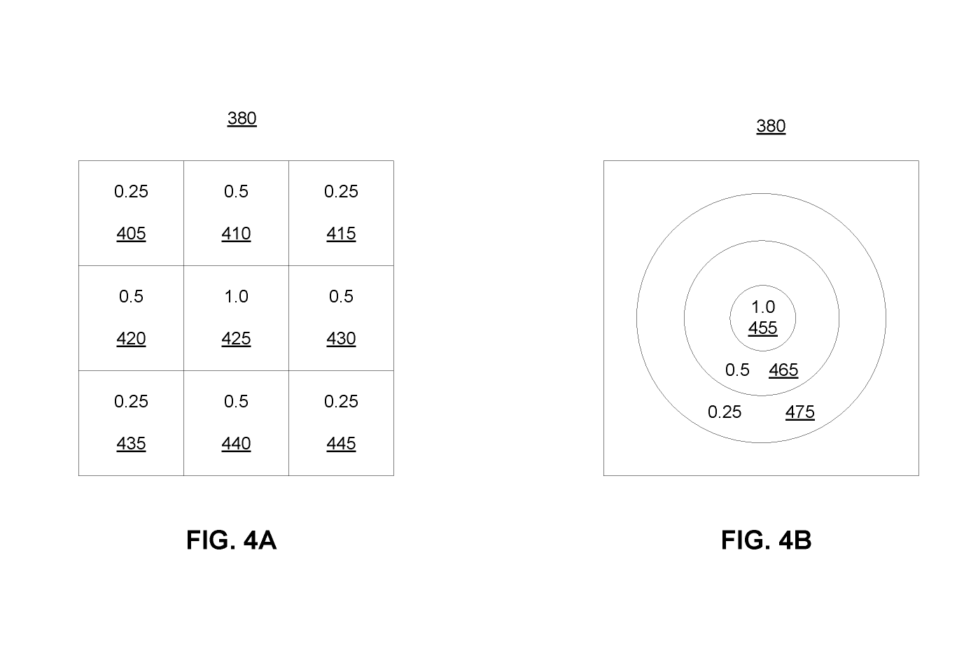

The PC or host system 310 provides input data that is displayed on the OLED display panel 380 after appropriate rescaling or interpolation. The PC 310 provides input data to the data receive module 320, where the input data might not have the same resolution (also referred to as display resolution or pixel resolution) for an entire frame of input data. For a given frame of input data, for example, the input data includes a first resolution (e.g., a native resolution of the OLED display panel 380) for a first portion of the frame of input data corresponding to a first pixel region (e.g., region 425 of FIG. 4A) and a second resolution that is lower than the first resolution (e.g., lower than the native resolution of the OLED display panel 380) for a second pixel region (e.g., region 410 of FIG. 4A) that is the remaining portion of the frame of input data other than the first portion. In some embodiments, there may be more than two portions of the frame of input data with one or more portions at varying levels of high resolutions and the other portions at varying levels of lower resolutions. Examples of frames of input data with varying pixel resolution data for different pixel regions of the OLED display panel 380 are described further below in conjunction with FIGS. 4A and 4B.

The received input data is interpolated at the interpolation core module 340 to convert the input data into full resolution data before sending to the panel driver 350 for displaying on the OLED display panel 380. The input data received at the data receive module 320 is input data that includes certain portions of data at a resolution lower than the full resolution of the OLED display panel 380 on a per frame basis.

The interpolation core module 340 receives the input data and performs interpolation to convert the input data to full resolution data. For example, when the OLED display panel 380 is being displayed at 1080 p resolution, the input data sent to the interpolation core module 340 may contain portions of data that is at a resolution lower than 1080 p (e.g., 720 p). In one embodiment, rescale factors for interpolating the input data to full resolution are set on a per-row basis (i.e., one or more rows at a time), per-column basis (i.e., one or more columns at a time), per-region basis (e.g., as shown in FIG. 4A), or radial basis (e.g., as shown in FIG. 4B), or some other regional bases.

FIG. 4A is a diagram depicting a mapping of a region-based (or grid-based) non-uniform rescaled data to be displayed on an OLED display device, in accordance with an embodiment. In this embodiment, the OLED display panel 380 is divided into nine regions, 405 through 445, for mapping the input data that will be displayed on the panel. Each region of the nine regions can include a plurality of pixels. The input data being mapped to each region can be separately and independently rescaled using a different rescaling factor. For example, the input data corresponding to the region 425 that is mapped to the center of the OLED display panel 380 has a rescaling factor of 1.0. That is, input data corresponding to region 425 is not altered at the interpolation core module 340 before sending to panel driver 350. In other words, the data corresponding to region 425 in the input data is already at full resolution before reaching the interpolation core module 340.

Input data corresponding to other regions that are mapped to other portions of the panel 380 have rescaling factors lower than 1.0 such as 0.5 (e.g., region 410) and 0.25 (e.g., region 405). Accordingly, input data corresponding to region 410 and 405 are interpolated with their respective rescaling factors before being sent to the panel driver 350. Interpolation can include either a simple interpolation of replicating an adjacent pixel with the value of the preceding pixel. Alternatively, interpolation can include other techniques such as linear interpolation, bilinear interpolation, spline interpolation, and the like. The rescaling factors are configurable and can be configured based on the interpolation technique used.

In one embodiment, the highest resolution of data displayed on the display panel may be equal to the full resolution (i.e., native resolution) of the OLED display panel 380. In other embodiments, the highest resolution of data displayed on the display panel need not be equal to the full resolution (i.e., native resolution) of the OLED display panel 380 but a resolution that is lower than the full resolution. For example, when the full resolution is 1920×1080 pixels, the high resolution may be 1280×720 pixels, which is lower than the full resolution. For this example, the highest rescaling factor would be less than 1.0 and would be based on a comparison between the actual resolution (i.e., 1280×720 pixels) and the full resolution (i.e., 1920×1080 pixels).

FIG. 4B is a diagram depicting a radial mapping of non-uniform rescaled data to be displayed on an OLED display device, in accordance with an embodiment. In this embodiment, the OLED display panel 380 is divided into circular regions, 455, 465, and 475, for mapping the input data that will be displayed on the panel, as opposed to regions based on grids of rows and columns in FIG. 4A. The data mapping for each circular region of FIG. 4B is similar to that of regions of FIG. 4A except that the interpolation is generally more complicated. To facilitate the interpolation for radial mapping of FIG. 4B, coordinate calculator module 370 computes the row and column pixel coordinates that correspond to each circular region.

In some embodiments, the input data provided by the PC 310 to the data receive module 320 includes a mapping between the different regions of the OLED display panel 380 and their corresponding rescaling factors. For example, the input data includes a lookup table that provides mapping between the nine regions of the display panel in FIG. 4A and their corresponding rescaling factors. The data receive module 320 and panel driver 350 interface with input buffer 330 and output buffer 360 for driving the OLED display panel. The panel driver 350 is typically included in the driver IC that drives the OLED display panel 380.

The rescaling factors may be determined in one or more of at least three different methods such as a static method based on the physical properties of human eye and the display panel, a dynamic method using eye tracking of the viewer of the headset, and a content-based method depending on the content being displayed. In the static method, a mapping between the various regions of the display panel and their corresponding rescaling factors is fixed and does not change with time. For example, the data corresponding to the regions of FIG. 4A are always rescaled with the same rescaling factors irrespective of where the user is looking at or what type of content is being displayed.

In the dynamic method, the rescaling factors are dynamically computed based on where the user is looking at, which may be determined by using eye tracking. In one embodiment, a region (either radial or grid-based) of the OLED display panel 380 with full resolution can be dynamically changed using an eye tracking device. In one embodiment, the eye tracking device comprises a camera (e.g., sensor 390) that is mounted within the VR headset (either within or outside of the OLED display panel 380). A user's fovea is responsible for sharp central vision (also called foveal vision), which is necessary for human activities such as reading and viewing images or video, where visual detail is of primary importance. The user's fovea can be tracked using an eye tracker such that the region of the OLED display device 380 that the user's is looking at (by tracking the user's fovea) can always be presented with data at full resolution and the other portions of the display can be presented with rescaled data to minimize the latency and bandwidth needed for transmitting display data. For example, the full resolution regions (e.g., region 425 in FIG. 4A and region 455 in FIG. 4B) are centered or otherwise moved in relation to the user's fovea. When the user's fovea moves from one portion to a different portion of the display panel 380 (e.g., from region 425 to region 410 in FIG. 4A), the user's fovea's position relative to the display panel region is tracked by the sensor 390 and relayed back to the PC/host system 310. The host system 310 dynamically modifies the input data to account for the change in the position of the user's fovea such that the data corresponding to region 410 of FIG. 4A is transmitted in full resolution and data corresponding to other regions (e.g., region 425 after user's fovea moved from region 425 to 410) are at lower resolution. The modified input data is then processed by the interpolation core module 340 to dynamically apply rescaling factors based on the modified input data such that the user views full resolution data in region 410 and lower resolution data in the other regions of the OLED display panel 380.

In the content-based method, the rescaling factors are determined based on the content being displayed on the OLED display panel 380. As the PC 310 device is aware of the characteristics of the content that is being rendered for display on the OLED display panel 380, the PC 310 is able to compute the rescaling factors for the regions on a per frame basis before sending the data to the data receive module 320. For example, if the PC 310 determines that regions 425 and 430 of FIG. 4A need higher resolution than the rest of the regions, PC 310 will adjust the input data and compute the rescaling factors accordingly before sending the data to data receive module 320.

In some embodiments, the data corresponding to boundaries between one region and another region of the OLED display panel 380 is smoothed to perform a gradual transition between the regions. For example, regions 425 and 430 of FIG. 4A have a rescaling factors of 1.0 and 0.5 respectively. If the interpolation core module 340 interpolates the data at the boundary of the regions 425 and 430 without applying any smoothing, the data changes abruptly from full resolution data at the last pixel of the region 425 to half resolution data at the first pixel of the region 430. Such abrupt transitions might reduce user experience and smoothing of data at region boundaries would improve the user experience. In one embodiment, smoothing operation may be applied at the boundary of regions 425 and 430 such that the data corresponding to the last few pixels of region 425 and the first few pixels of region 430 may have a rescale factor that is in between the corresponding rescale factors of regions 425 and 430. For example, the pixels at the boundary of regions 425 and 430 may have a rescale factor that is linear average of the rescale factors of the regions 425 and 430 (i.e., 0.75). Smoothing of the data may be implemented using smoothing filters such as low-pass filter, moving average filter, exponential smoothing filter, and the like. The smoothing filter operation may be implemented in hardware, firmware, software, or some combination thereof.

In some embodiments, the input data received at the data receive module 320 may be compressed to reduce the size of data instead of being scaled at different resolutions for different regions as described above in conjunction with FIG. 3. In this embodiment, the data received may include data at full resolution corresponding to all regions of the OLED display panel 380 instead of data corresponding to different regions being scaled differently as described in conjunction with FIG. 3. For this embodiment, the interpolation core 340 performs decompression of the compressed data before displaying on the OLED display panel 380. The scaling and interpolation described above in conjunction with FIG. 3 can be thought of as a simple method of compression and decompression, as for example, input data corresponding to the region 430 of FIG. 4A (with rescaling factor=0.5) is being transmitted at every other pixel row (or column) instead of sending for every pixel row (or column). The input data is then rescaled back to full resolution to fill in the data for the missing rows (or columns) by using the rescaling factor such as, for example, duplicating each row (or each column) to its adjacent row (or column). The input data received at data receive module 320 may be compressed using more sophisticated video compression schemes such as H.264, MPEG-4, H.265, and the like. The interpolation core module 340 decompresses the received input data using techniques corresponding to the specific compression scheme used for compressing the data. The compression and decompression of the data may be implemented in hardware, software, firmware, or some combination thereof.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosed embodiments are intended to be illustrative, but not limiting, of the scope of the disclosure, which is set forth in the following claims.

What is claimed is:

1. A method for rescaling data to be displayed on a display device, the method comprising:
receiving a frame of data for displaying on the display device, the received frame of data comprising a first portion of the data corresponding to a first pixel region at a first pixel resolution and a second portion of the data corresponding to a second pixel region at a second pixel resolution lower than the first pixel resolution;
rescaling the received frame of data for displaying the received data at a native pixel resolution of the display device, the rescaling of the received frame of data comprising scaling the first portion of the data using a first scaling factor and the second portion of the data using a second scaling factor; and
providing the rescaled frame of data for displaying on the display device.

2. The method of claim 1, wherein the received frame of data comprises a mapping between the first pixel region and the first scaling factor, and the second pixel region and the second scaling factor.

3. The method of claim 2, wherein the mapping between the first pixel region, the second pixel region, the first scaling factor, and the second scaling factor is fixed over time.

4. The method of claim 2, wherein the mapping between the first pixel region, the second pixel region, the first scaling factor, and the second scaling factor varies based on eye tracking of a user viewing content on the display device.

5. The method of claim 2, wherein the mapping between the first pixel region, the second pixel region, the first scaling factor, and the second scaling factor varies based on characteristics of content being displayed on the display device.

6. The method of claim 1, wherein the received frame of data is compressed to reduce size of the data, and wherein each of the first scaling factor and the second scaling factor is determined based on properties of compression used for compressing the data.

7. The method of claim 1, wherein the first pixel resolution is the native pixel resolution of the display device.

8. The method of claim 1, wherein the display device is an organic light emitting diode (OLED) display device.

9. A display device comprising:
a display panel configured to display data at a native pixel resolution, the display panel comprising two or more pixel regions,
a data receive module configured to receive a frame of data for displaying on the display device, the received frame of data comprising a first portion of the data corresponding to a first pixel region of the two or more pixel regions at the first pixel resolution and a second portion of the data corresponding to a second pixel region of the two or more pixel regions at a second pixel resolution lower than the first pixel resolution;
an interpolation core module configured to rescale the received frame of data for displaying the received data at the native pixel resolution of the display device, the rescaling of the received frame of data comprising scaling the first portion of the data using a first scaling factor and the second portion of the data using a second scaling factor.

10. The display device of claim 8, wherein the data receive module is further configured to receive a mapping between the first pixel region and the first scaling factor, and the second pixel region and the second scaling factor.

11. The display device of claim 9, wherein the data receive module is further configured such that the mapping between the first pixel region, the second pixel region, the first scaling factor, and the second scaling factor is fixed over time.

12. The display device of claim 9, wherein the data receive module is further configured such that the mapping between the first pixel region, the second pixel region, the first scaling factor, and the second scaling factor varies based on eye tracking of a user viewing content on the display device.

13. The display device of claim 9, wherein the data receive module is further configured such that the mapping between the first pixel region, the second pixel region, the first scaling factor, and the second scaling factor varies based on characteristics of content being displayed on the display device.

14. The display device of claim 8, wherein the data receive module is further configured to receive the frame of data that is compressed to reduce size of the data, and such that each of the first scaling factor and the second scaling factor is determined based on properties of compression used for compressing the data.

15. The display device of claim 8, wherein the first pixel resolution is the native pixel resolution of the display device.

16. The display device of claim 8, wherein the display device is an organic light emitting diode (OLED) display device.

17. The display device of claim 8, wherein the interpolation core module is further configured to apply a smoothing filter for data corresponding to a boundary between the first pixel region and the second pixel region, smoothing filter.
